(19) United States
(12) Patent Application Publication
(10) Pub. No.: US 2005/0273588 A1
(43) Pub. Date: Dec. 8, 2005

(54) Bootstrap method and apparatus with plural interchangeable boot code images

(76) Inventors: Soo Keong Ong, Penang (MY); Peter Trinh, Folsom, CA (US); Douglas P. Bogia, Hillsboro, OR (US); Chetan Hiremath, Hillsboro, OR (US); Tisson K. Mathew, Hillsboro, OR (US)

Correspondence Address: BUCKLEY, MASCHOFF, TALWALKAR LLC, 5 ELM STREET, NEW CANAAN, CT, 06840, US

(21) Appl. No.: 10/863,425

(22) Filed: Jun. 8, 2004

(51) Int. Cl. G06F 15/177

(52) U.S. Cl. 713/2

(57) ABSTRACT

A method includes storing a plurality of interchangeable BIOS images, selecting a first one of the BIOS images, and attempting to perform a boot procedure using the selected first one of the BIOS images. If the boot procedure is performed successfully, a signal is sent to control logic. If the control logic does not receive the signal: (a) a second one of the BIOS images is selected, (b) a reset condition is initiated, and (c) in response to the reset condition, an attempt is made to perform a boot procedure using the selected second one of the BIOS images.

### BACKGROUND

Upon being powered up, or in response to a reset condition, conventional microcomputers, and other devices controlled by a programmable microprocessor or microcontroller, undergo an initialization process known as “booting”. The boot process generally involves initializing peripheral devices such as disk drives (if present), and loading an operating system or kernel into main memory (random access memory or “RAM”) so that program execution may be performed as required for operation of the system. The software that controls the boot process is sometimes referred to as boot code and may be stored in a ROM (read only memory) or a flash memory. One widely used type of boot code is the Basic Input Output System, known as “BIOS”.

Boot code may be subject to corruption under some circumstances, and if the boot code is corrupted, the boot process may fail.

It has been proposed to try to prevent some portion of the boot code from being corrupted by write-protecting the portion of flash memory in which that portion of boot code is stored. The protected portion may then be used to perform a validation process (e.g., a checksum) on all of the boot code to determine whether corruption has occurred. If so, a non-corrupted image of the boot code may be recovered from a storage device such as a floppy disk. A disadvantage of this approach is that user intervention may be required.

According to another proposal, two boot code images—a main image and a backup image—may be stored. The backup image may be a known good boot code version and/or may be write-protected. The backup image may be executed initially on power-up or reset to validate the main image, which is then executed to control the balance of the boot process. If the boot process fails while using the main image, the system may automatically switch back to the backup image, which then continues the boot process. The boot process may also continue with the backup image if the routine for validating the main image indicates that the main image may be corrupted.

The latter proposal allows the main boot code image to be updated, while relying on a somewhat different backup version to detect corruption in the main image and to carry on with booting if necessary, without user intervention. However, it cannot be absolutely assured that the backup is or will remain free of corruption. For example, it may be necessary to allow for updating of the backup boot code image in the case of a major boot code revision. The updating process, or even just the mechanism which allows for updating, may permit the backup image to be corrupted, in which case the entire boot process may fail.

According to a third proposal, two, possibly identical, boot code images are stored, but only a limited portion of each is write protected. The main image performs a self-validation using its protected portion (as in the first proposal described above). If the validation fails, then the protected portion of the main image causes the system to proceed with booting with the backup image, without user intervention. Again, however, the need to at least allow for updating of the protected portion of the main image also allows for the possibility that the protected portion may be corrupted. If this occurs, then, as in the second proposal, the entire boot process may fail.

Thus there is a need for a boot process that does not depend on a specific boot code image, either main or backup, to be free of corruption. This need is particularly pressing in the case of processor-controlled communication equipment, for which “high availability” may be desired.

### BRIEF DESCRIPTION OF THE DRAWINGS

FIG. 1 is block diagram of a computer system according to some embodiments.

FIG. 2 is a functional block diagram of a BIOS image switching arrangement that is part of the computer system of FIG. 1.

FIGS. 3 and 4 are flow charts that illustrate processes that may be performed in the computer system of FIG. 1 according to some embodiments.

### DETAILED DESCRIPTION

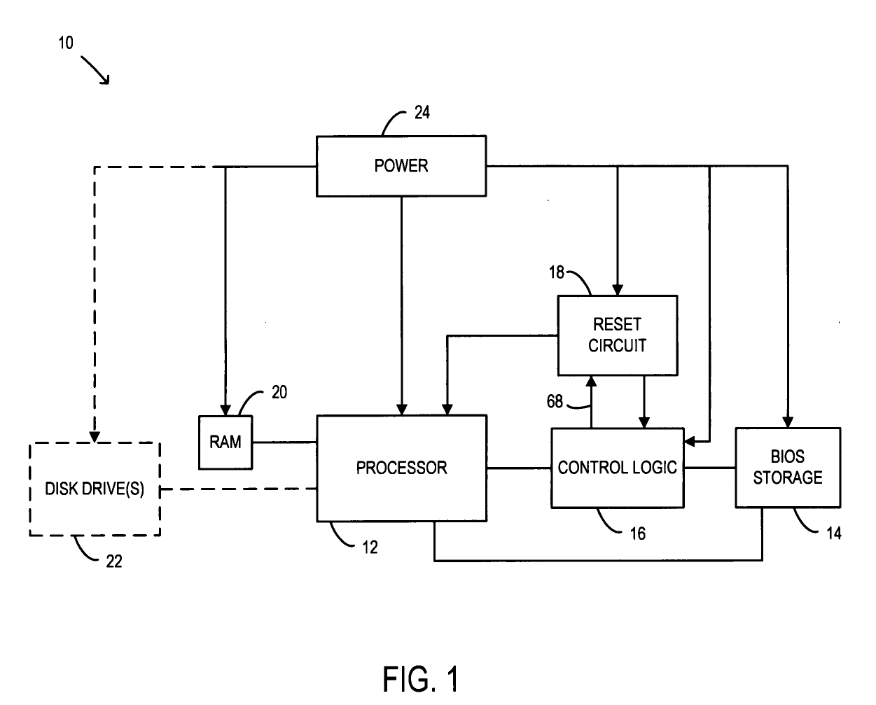

FIG. 1 is a block diagram of a computer system 10 according to some embodiments. The computer system 10 includes a processor 12 which generally controls the computer system 10 and which operates under the control of a stored program. The processor 12 may be a conventional microprocessor or microcontroller or any other type of processor, now known or hereafter developed, which operates under the control of a stored program.

In some embodiments, the processor 12 may include chipset functionality which includes, for example, a memory controller hub (MCH) and/or an I/O (input/output) controller hub (ICH). For example, the processor may connect to RAM (discussed below) with a MCH rather than directly. Similarly, a reset vector interface may connect to the processor either via an ICH (if present) or directly. Also, the control/switching logic which is discussed below may connect either directly to the processor or via an ICH.

The computer system 10 also includes one or more memory devices 14 (e.g. a ROM or ROMs or a flash memory device or devices), in which two or more BIOS images are stored. The BIOS images may be identical or interchangeable. BIOS images are to be considered “interchangeable” if stored from a single source, from identical sources or from sources configured to result in essentially identical operation of the processor 12. It will be appreciated that if only one memory device 14 is provided for BIOS storage, then all of the BIOS images, whether two or more than two, are stored in that one BIOS storage device. If more than one memory device is included in the system 10 for storage of the BIOS images, then at least one of the BIOS images may be stored in a first one of the memory devices and at least one other of the BIOS images may be stored in a second (different) one of the memory devices.

As used in this description of computer system 10 and in the appended claims, “BIOS” refers to the above-mentioned Basic Input Output System and/or to any other bootstrap firmware for a computer system motherboard or for another device that includes a processor or controller.

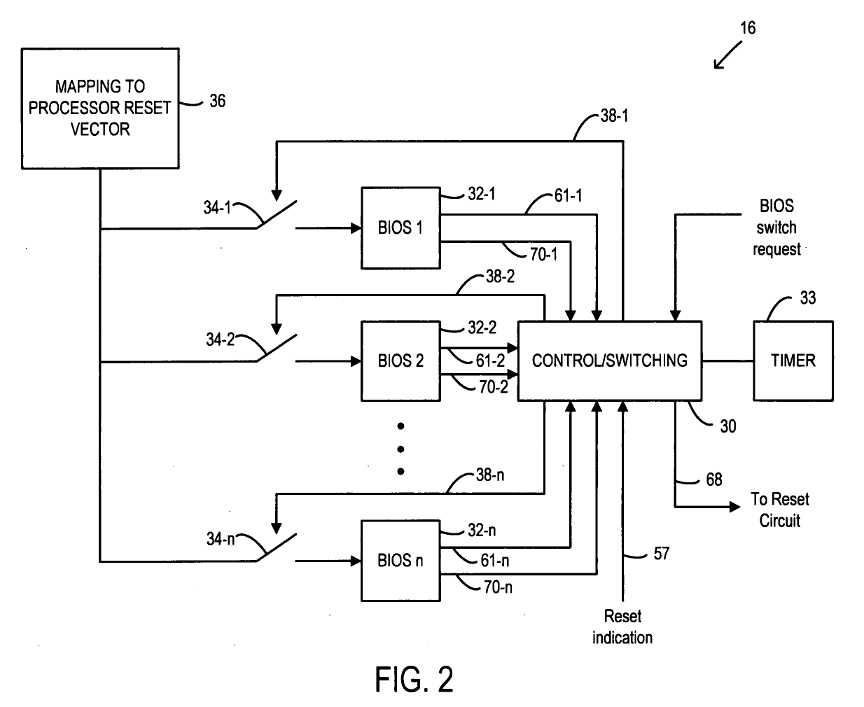

The computer system 10 further includes control logic 16 that is coupled to the processor 12 and to the memory device(s) 14 in which the BIOS images are stored. The control logic is provided in accordance with some embodiments to allow the computer system to boot notwithstanding that any one (or possibly more than one in some embodiments) of the BIOS images may be corrupted. The control logic 16 may, in some embodiments, be constituted by suitably configured PAL (programmable array logic) or PLD (programmable logic device) or by a suitably programmed IPMI (Intelligent Platform Management Interface) microcontroller. Details of operation of the control logic 16 will be provided below in connection with FIGS. 2-4.

Also included in the computer system 10 is a reset circuit 18 which is coupled to the processor 12 and the control logic 16. The reset circuit 18 may operate to initiate a reset condition under certain circumstances such as actuation by a user of a reset button (not shown). The reset condition initiated by the reset circuit 18 may involve assertion of an active signal on a reset pin or pins (not separately shown) that cause the processor to enter into a boot mode. As will be seen, the reset circuit may also operate to initiate a reset condition in response to a signal received by the reset circuit from the control logic.

In addition, the computer system 10 includes main memory (RAM) 20 coupled to the processor 12. Operating system software, device drivers, etc. may be loaded into the RAM 20 as part of the boot process. Also, in some embodiments, the computer system 10 may include one or more disk drives 22 (e.g., one or more floppy disk drives and/or one or more hard disk drives; shown in phantom) that are coupled to the processor 12. The disk drive(s) 22 may, for example, be the source of operating system software and/or other software loaded into the RAM 20 in the boot process.

The computer system 10 further includes a power supply 24 which may be a source of power for all of the above-enumerated electrical or electronic components of the computer system 10. In some embodiments, the power supply 24 may be turned on and/or off by one or more switches or buttons (not separately shown) that are actuatable by a user of the computer system. When the power supply 24 is turned from off to on, the computer system is said to be “powered up”, and a reset condition is entered by the computer system, followed by a boot mode.

In some embodiments, the computer system 10 may include one or more other nonvolatile memory devices, including nonvolatile program storage, in addition to the memory device(s) 14 used to store the BIOS images. Data and or software other than the BIOS images may be stored in the same memory device(s) with the BIOS images. The computer system may also include one or more input/output devices (not shown) coupled to the processor. Such input/output devices may include a computer monitor, a keyboard, a computer mouse.

FIG. 2 is a functional block diagram of the control logic 16 and related aspects of the computer system 10. Block 30 in FIG. 2 represents control and switching functions of the control logic 16. Blocks 32-1 to 32-n each represents a respective one of the above-mentioned BIOS images stored in the memory device(s) 14 (FIG. 1). (Although FIG. 2 suggests that the number of BIOS images may be three or more, in other embodiments the number of BIOS images may be only two.)

Block 33 in FIG. 2 represents a timer function which is under the control of the control/switching function and which may control some aspects of the control/switching function.

Also shown in FIG. 2 are “switches” 34-1 to 34-n, each of which is associated with a respective one of the BIOS images 32, and which, if “closed” indicates that the respective BIOS image 32 is mapped (block 36) to the reset vector of the processor 12 so that the respective BIOS image 32 is executed by the processor 12 upon initiation of a reset condition. (For purposes of illustration, all of the “switches” 34 are shown as “open”, but in practice the control/switching function 30 is arranged and operates such that at any given time one and only one of the “switches” 34 is “closed”. That is, at any given time one and only one of the BIOS images 32 is mapped to the reset vector of the processor 12. Control of the “switches” 34 by the control and switching function 30 is schematically indicated by lines 38-1 to 38-n.)

Inputs to the control and switching function 30 and details of operation of the control and switching function 30 will be described below.

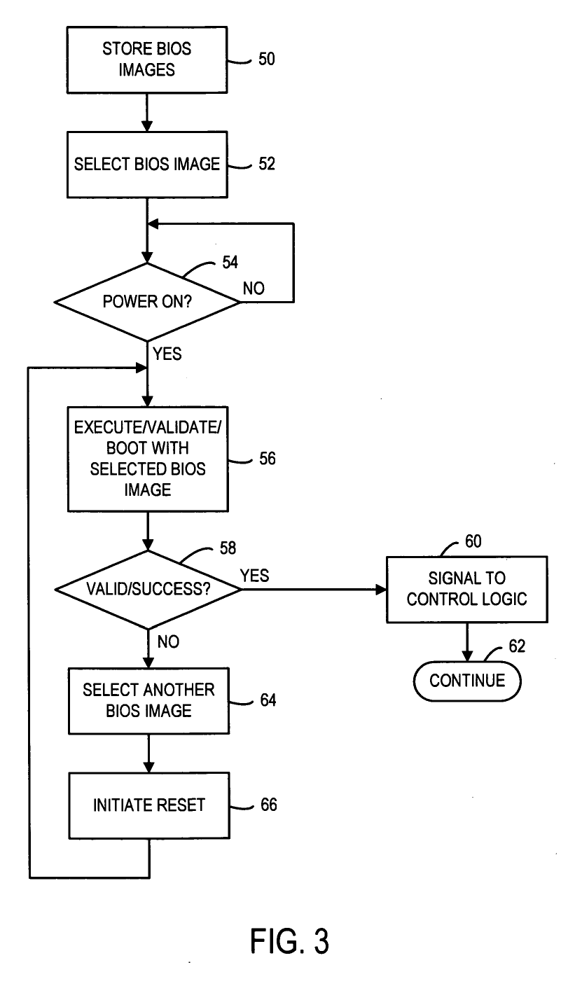

FIG. 3 is a flow chart that illustrates a process that may be performed by the computer system 10 according to some embodiments.

At 50 in FIG. 3, storing of the BIOS images 32 (FIG. 2) in the memory device(s) 14 is indicated. As used herein and in the appended claims, “storing” software such as a BIOS image refers to one or both of transferring the software for storage in a device (e.g., a memory device) and holding the software in the device to be available for potential or actual retrieval and/or transfer for execution by a processor and/or for storage in another device.

As indicated at 52, the control logic 16 (FIG. 1) and in particular its control and switching function 30 is configured to select one of the BIOS images 32. The selected BIOS image 32 is mapped by the control logic 16 and its control and switching function 30 to the reset vector of the processor 12 for execution by the processor 12 immediately upon occurrence of a reset.

At 54 in FIG. 3 it is determined whether the power supply 24 (FIG. 2) has been turned from off to on so that the computer system 10 is powered up. The power supply sequence may apply power to the control logic 16 prior to the reset circuit 18 to assure that the selection of a BIOS image by the control logic 16 is complete before the reset takes effect. (In other embodiments, power is applied simultaneously to the whole system including the control logic 16 and reset circuit 18, and the reset circuit 18 operates to apply a shorter reset condition to the control logic 16 than to other components, so that the control logic commences to operate prior to the rest of the system. As a result, the control logic completes selection of a BIOS image before the rest of the system comes out of reset.) In response to the powering up of the computer system and immediately upon the powering up of the computer system, the resulting reset condition causes the processor 12 to execute the BIOS image 32 which was selected by the control and switching function 30 (FIG. 2) of the control logic 16 at function 52 shown in FIG. 3. In executing the BIOS image, in some embodiments, a validation procedure such as verification of a checksum is performed with respect to the BIOS image currently being executed to determine whether that BIOS image is valid. If so, performing of a boot procedure proceeds using the currently executing BIOS image. In other embodiments, performing of a boot procedure proceeds without first validating the currently executing BIOS image. Execution of the currently selected BIOS image, validation of the selected BIOS image (if performed), and performing a boot procedure using the selected BIOS image are all indicated at 56 in FIG. 3.

Also in response to the reset resulting from powering up of the computer system, the control and switching function 30 of the control logic 16 starts the timer 33 (FIG. 2), the purpose of which is described below. The input to the control and switching function which indicates occurrence of a reset condition is indicated at 57 in FIG. 2.

At 58 in FIG. 3, it is determined whether the selected BIOS image was found to be valid and/or whether the boot procedure attempted at 56 was performed successfully. If a positive determination is made in either respect, a predetermined signal may be sent to the control and switching function 30 of the control logic 16 (e.g., by the processor 12 under control of the currently selected BIOS image) to confirm either that the currently selected BIOS image has been determined to be valid, or that the boot procedure has been performed successfully using the currently selected BIOS image (or to indicate both of these facts). The sending of this signal (which may be referred to as a “startup signature”) is indicated at 60 in FIG. 3. The startup signature may be only a single bit in some embodiments, or may be a particular multibit or multibyte code that the control and switching function is able to interpret as confirmation of the satisfactory state of the BIOS image currently selected by the control logic 16. Lines 61-1 to 61-n in FIG. 2 schematically illustrate channels available for the transmission of the startup signature to the control and switching function from whichever one of the BIOS images 32 is currently selected. Again it will be noted that in practice the startup signature may be transmitted to the control logic 16 by the processor 12 on behalf of the BIOS image currently executed by the processor 12.

After sending the startup signature at 60, normal operation of the processor 12 and of the system 10 continues, as indicated at 62. In the case where the startup signature is sent to the control logic 16 upon determining that the currently executing BIOS image is valid and before completion of the boot procedure, the continuing normal operation indicated at 62 may include completion of the boot procedure.

Upon receiving the startup signature, control and switching function 30 (FIG. 2) disables the timer 33.

If at 58 it is determined that the boot procedure failed and/or the currently executing BIOS image was not found to be valid, the startup signature is not sent to the control logic. Accordingly, the timer 33 is not disabled and times out. In response to the timing out of the timer 33, the control and switching function 30 de-selects the previously selected BIOS image and (as indicated at 64 in FIG. 3) selects another one of the BIOS images, and maps the other BIOS image to the reset vector of the processor 12. For example the BIOS image selected at 64 may be the next BIOS image in an array of BIOS images.

In some embodiments, the timing out of the timer 33 may cause an event to be logged (e.g., to an IMPI System Event Log) to indicate that the previous BIOS image failed. In addition or alternatively, a suitable error notice may be displayed to a user.

Also in response to the timing out of the timer 33, the control and switching function 30 controls the reset circuit 18 (FIG. 1) to initiate a reset condition, as indicated at 66 in FIG. 3. (The signal path by which the control logic 16 initiates the reset condition is indicated at 68 in FIGS. 1 and 2.)

In some embodiments, the control logic 16 may operate such that it completes its selection of another BIOS image and the mapping of that BIOS image to the processor reset vector before the reset condition is released, to assure that the processor executes another BIOS image as a result of the reset condition. Thus, the process of FIG. 3 loops back from 66 to 56, and the processor 12 executes the BIOS image selected at 64, in response to the reset condition initiated at 66, and proceeds to validate that BIOS image and/or to perform a boot procedure using that BIOS image. As before, validation of the currently executing BIOS image, or successful performing of the boot procedure using the currently executing BIOS image, results in the startup signature being sent to the control logic 16 so that the timer does not trigger the control logic to switch to another BIOS image, the control logic does not switch to another BIOS image and initiate a reset, and normal operation of the computer system proceeds. But if validation fails and/or the boot procedure fails with respect to the BIOS image selected at 64, then the startup signature is not sent, the control logic 16 switches to still another BIOS image (if any), another reset is initiated by the control logic, and the process again loops back to 56, so that the processor executes the newly selected BIOS image in response to the most recent reset.

The loop of functions 56, 58, 64, 66 may be reiterated indefinitely, or until the boot procedure is performed successfully using a currently executing one of the BIOS images 32 (FIG. 2), or until all BIOS images have been selected in turn without resulting in a successful boot.

With this arrangement of stored BIOS images and with control logic operating as described above, even if the first BIOS image executed on power-up or other reset is corrupted, the system is able to switch without user intervention to another BIOS image from which the boot procedure may be successfully performed. More generally, if n (greater than one) BIOS images are stored in the memory device(s) 14, the system will boot properly without user intervention even if all but one of the BIOS images are corrupted. Theoretically, n may be any number (greater than one), limited only by the storage capacity of the memory device(s) 14. Moreover, this arrangement does not rely on a particular BIOS image being non-corrupted.

The loop of 56-58-64-66 in FIG. 3 may be repeated until a non-corrupted BIOS image is selected. In some embodiments, the control and switching function 30 may be arranged to determine when all of the BIOS images have been tried unsuccessfully, and to end the loop at that point. In that case a suitable error message may be logged and/or delivered to the user.

In some embodiments, the control logic may store an indication as to which BIOS image most recently was used for a successful boot process, and the indicated BIOS image may then be used for booting upon subsequent resets or power-ons.

In some embodiments, if a determination is made at 58 that the currently executing BIOS is not valid (e.g., the checksum failed), then, instead of waiting for the timer 33 (FIG. 2) to time out, a signal may be provided to the control/switching function to cause the control and switching function to select another BIOS and to initiate a reset. Lines 70-1 to 70-n in FIG. 2 schematically illustrate channels available for the transmission of such a signal to the control and switching function from whichever one of the BIOS images 32 is currently selected. In practice the signal may be transmitted to the control logic 16 by the processor 12 on behalf of the BIOS image currently executed by the processor 12.

In some embodiments, the BIOS images may be configured such that a user boot set up option or other user input is delayed until after the startup signature is sent to the control logic. To do otherwise may risk allowing the timer 33 to time out (thereby causing selection of a new BIOS image and initiation of a reset) even though the currently executing BIOS image is executing normally.

The sequence of functions starting at 56 in FIG. 3 may also be entered upon occurrence of a reset other than a power-on reset. Such other reset may be, for example, a “soft” reset (initiated by software without asserting an active signal on a reset pin) or a “hard” reset (caused by an active signal on a reset pin, whether resulting from action by software or from a hardware source such as a user-actuated reset).

In some embodiments, when a BIOS image fails to be validated and/or fails to result in successful booting, and another BIOS image is selected and successfully boots, the “bad” BIOS image may be replaced (re-programmed) in the memory device 14 by a BIOS image that is believed to be “good”. For example, a suitable flag or flags may be set in the control logic 16 to identify a BIOS image or images that failed at one or another iteration (including the first iteration) of 58 in FIG. 3.

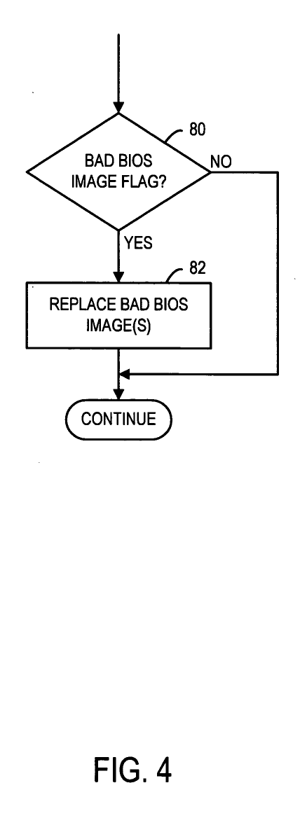

FIG. 4 is a block diagram of a process according to some embodiments for replacing a bad BIOS image or images. Block 80 in FIG. 4 indicates a determination as to whether at least one flag has been set to indicate and/or identify a bad BIOS image. If a positive determination is made at 80, then, as indicated at 82, the bad BIOS image or images are replaced. In some embodiments, the bad BIOS image or images are replaced with an image of the BIOS image that most recently executed in the processor to result in the successful boot that was just completed. In another embodiment, the bad BIOS image or images are replaced with a BIOS image sourced from a storage device such as another ROM or flash memory or from a hard drive or floppy disk.

In some embodiments, the control logic 16 is made aware of every reset, whether hard or soft or upon power-up, and in the case of every reset, the control logic sets the timer 33 (FIG. 2) and, if the startup signature is not received prior to the timer timing out, the control logic switches the BIOS image and initiates another reset. In other embodiments, certain resets are not indicated to the control logic 12.

In some embodiments the BIOS may cause several resets to occur. It may be desirable in such cases for the control logic to reset the timer on each occurrence of a reset even though the timer is already running, to give the BIOS adequate time to self-validate and/or to complete the boot procedure before the timer times out.

In some embodiments, the BIOS execution flow may bypass some BIOS code in the case of certain resets. In such embodiments, it may be desirable not to bypass the code which performs the functions of self-validation and sending the startup signature, as referred to above. In other embodiments, if the portion of the BIOS code which sends the startup signature is bypassed in response to some resets, and if the control logic is made aware of such resets, the control logic may be configured to mask off the BIOS switching capability in the case of such resets.

In some embodiments, one or more other BIOS images may be accessible to the software executed by the processor 12, in addition to the BIOS image currently mapped to the memory address range that covers the processor reset vector. This may be done to facilitate updating of a BIOS image that is not currently selected for use in the boot procedure. Assume for example that the processor reset vector is 0xFFFFFFF0 and that two 1-megabyte BIOS images are implemented. Then, in some embodiments, the first BIOS image may occupy the memory address range 0xFFF00000 to 0xFFFFFFFF, covering the processor reset vector, and the second BIOS image may occupy the memory address range 0xFFE00000 to 0xFFEFFFFF. Upon a reset, the system will try to boot using the first BIOS image. If the boot fails and the control logic switches to the second BIOS image, the second BIOS image may be mapped to the memory address range 0xFFF00000 to 0xFFFFFFFF and the first BIOS image may be mapped to the memory address range 0xFFE00000 to 0xFFEFFFFF. Upon the reset initiated by the control logic, the system will attempt to boot using the second BIOS image. If the boot procedure is now successful, the software which controls the processor has access to both BIOS images.

In some embodiments, the control logic 16 may be configured to switch between BIOS images in response to a software command (i.e. in response to a command issued by the processor 12 under the control of software which programs the processor), without a reset. In such cases the control logic may not initiate a reset upon switching between the BIOS images. In some embodiments, only one BIOS image may be visible in system memory at a given time, but an invisible BIOS image may become accessible by being mapped into the memory address range that covers the processor reset vector in response to a software command.

In some embodiments, the control logic may be configured to enable and disable write protection on one or more of the BIOS images on an individual basis.

In some embodiments, the system may be configured to permit the user to use a manual method (e.g., a jumper) to enable and disable write protection for one or more of the BIOS images on an individual basis.

In some embodiments, the system may be configured to permit the user to use a manual method (e.g., a jumper) to cause the control logic to switch between BIOS images.

In some embodiments, the control logic may examine the stored BIOS images to attempt to determine which one or ones of the BIOS images are “good”. The control logic may then select a “good” BIOS image in preference to other BIOS images. For example, if there are three or more stored BIOS images, the control logic may compare the BIOS images to each other, and if one or the stored BIOS images does not match the others, that one of the stored BIOS images may be the last one selected for attempted booting.

In some embodiments, in the case of a BIOS upgrade, if booting is unsuccessful with a new BIOS image the control logic may select an older BIOS image for the next boot attempt.

As used herein and in the appended claims, “computer system” refers to any device that includes a microprocessor, including servers, personal computers, laptop computers, and communication devices such as network controllers and routers.

As used herein and in the appended claims, “reset condition” includes one or more of (a) powering-on of a computer system, (b) a reset asserted by an active signal on a reset pin, and (c) a reset initiated by a software routine without assertion of an active signal on a reset pin.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

1. A method comprising:
storing a plurality of interchangeable BIOS images;
selecting a first one of the BIOS images;
attempting to perform a boot procedure using the selected first one of the BIOS images;
if the boot procedure is performed successfully, sending a signal to control logic; and
if the control logic does not receive the signal:
selecting a second one of the BIOS images;
initiating a reset condition; and
in response to the reset condition, attempting to perform a boot procedure using the selected second one of the BIOS images.

2. The method of claim 1, wherein the plurality of BIOS images includes at least three BIOS images, and further comprising:
if the boot procedure is performed successfully using the second one of the BIOS images, sending the signal to the control logic;
if the control logic does not receive the signal after the attempting to perform a boot procedure using the second one of the BIOS images:
selecting a third one of the BIOS images;
initiating a reset condition; and
attempting to perform a boot procedure using the selected third one of the BIOS images in response to the reset condition initiated after the attempting to perform a boot procedure using the second one of the BIOS images.

3. The method of claim 1, wherein the storing includes storing all of the BIOS images in the same memory device.

4. The method of claim 1, wherein the storing includes storing at least one of the BIOS images in a first memory device and storing at least one other of the BIOS images in a second memory device that is different from the first memory device.

5. The method of claim 1, further comprising:
if the boot procedure is performed successfully using the second one of the BIOS images, replacing the first one of the BIOS images with a BIOS image that is different from the first one of the BIOS images.

6. The method of claim 5, wherein the replacing includes replacing the first one of the BIOS images with an image of the second one of the BIOS images.

7. The method of claim 5, wherein the replacing includes replacing the first one of the BIOS images with a BIOS image from a storage device that is different from a device in which the first one of the BIOS images is stored.

8. The method of claim 7, wherein the storage device is one of a hard drive and a floppy disk.

9. The method of claim 1, further comprising:
logging an error message to indicate unsuccessful performance of a boot procedure.

10. A method comprising:
storing a plurality of interchangeable BIOS images;
selecting a first one of the BIOS images;
determining whether the selected first one of the BIOS images is valid;
if the first one of the BIOS images is determined to be valid:
sending a signal to control logic to indicate that the first one of the BIOS images is determined to be valid; and
performing a boot procedure using the first one of the BIOS images;
if the control logic does not receive the signal:
selecting a second one of the BIOS images;
initiating a reset condition; and
in response to the reset condition:
determining whether the selected second one of the BIOS images is valid; and
performing a boot procedure using the second one of the BIOS images if the second one of the BIOS images is determined to be valid.

11. The method of claim 10, wherein the plurality of BIOS images includes at least three BIOS images, and further comprising:
if the second one of the BIOS images is determined to be valid:
sending a signal to the control logic to indicate that the selected second one of the BIOS images is determined to be valid; and
performing a boot procedure using the second one of the BIOS images; and
if the control logic does not receive the signal to indicate that the second one of the BIOS images is determined to be valid:
selecting a third one of the BIOS images;
initiating a reset condition; and
in response to the reset condition initiated after the control logic fails to receive the signal to indicate that the second one of the BIOS images is determined to be valid:
determining whether the selected third one of the BIOS images is valid; and
performing a boot procedure using the third one of the BIOS images if the third one of the BIOS images is determined to be valid.

12. The method of claim 10, further comprising:
after performing the boot procedure using the second one of the BIOS images, replacing the first one of the BIOS images with another BIOS image.

13. The method of claim 12, wherein the replacing includes replacing the first one of the BIOS images with an image of the second one of the BIOS images.

14. The method of claim 10, wherein determining whether a BIOS image is valid includes performing a checksum operation.

15. A method comprising:
storing a plurality of BIOS images in a computer system;
selecting a first one of the BIOS images;
executing the selected first one of the BIOS images immediately upon powering-up of the computer system;
sending a signal to control logic if at least one of the following occurs: (a) a determination that the first one of the BIOS images is valid and (b) successful performance of a boot procedure using the first one of the BIOS images; and
if the control logic does not receive the signal:
selecting a second one of the BIOS images;
initiating a reset condition; and
executing the selected second one of the BIOS images in response to the reset condition.

16. The method of claim 15, wherein the plurality of BIOS images includes at least three BIOS images, and further comprising:
sending the signal to the control logic if at least one of the following occurs: (a) a determination that the second one of the BIOS images is valid and (b) successful performance of a boot procedure using the second one of the BIOS images; and
if the control logic does not receive the signal as a result of the executing of the second one of the BIOS images:
selecting a third one of the BIOS images;
initiating a reset condition; and
executing the selected third one of the BIOS images in response to the reset condition initiated after the executing of the second one of the BIOS images.

17. The method of claim 15, further comprising:
after performing the boot procedure using the second one of the BIOS images, replacing the first one of the BIOS images with another BIOS image.

18. The method of claim 17, wherein the replacing includes replacing the first one of the BIOS images with an image of the second one of the BIOS images.

19. A system comprising:
a processor;
at least one memory device, a plurality of interchangeable BIOS images stored in the at least one memory device; and
control logic, coupled to the at least one memory device and to the processor, to:
select a first one of the BIOS images for execution by the processor;
set a timer upon occurrence of a reset condition; and
if the control logic does not receive a predetermined signal prior to timing out of the timer:
select a second one of the BIOS images for execution by the processor; and
initiate a reset condition.

20. The system of claim 19, wherein the at least one memory device includes at least one flash memory.

21. The system of claim 19, wherein the first one of the BIOS images is executed by the processor immediately upon powering-up of the system.

22. The system of claim 19, wherein the first one of the BIOS images is replaced by another BIOS image after successful performance of a boot procedure using the second one of the BIOS images.

23. The system of claim 22, wherein the first one of the BIOS images is replaced by an image of the second one of the BIOS images.

24. The system of claim 22, further comprising a disk drive coupled to the processor, and wherein the first one of the BIOS images is replaced by a BIOS image from the disk drive.

25. The system of claim 19, wherein the control logic simultaneously maps two BIOS images into memory space that is accessible by the processor.

26. An apparatus comprising:
a storage medium having stored thereon a plurality of identical BIOS images, each BIOS image including instructions that when executed by a machine result in the following:
executing a selected one of the BIOS images; and
sending a signal to control logic if at least one of the following occurs: (a) a determination that the selected one of the BIOS images is valid and (b) successful performance of a boot procedure using the selected one of the BIOS images.

27. The apparatus of claim 26, wherein the storage medium is a flash memory.

28. The apparatus of claim 26, wherein the storage medium is a read only memory (ROM).
